(19) United States
(12) Patent Application Publication
(10) Pub. No.: US 2009/0152061 A1
(43) Pub. Date: Jun. 18, 2009

(54) Adjustable pumping device for a hydraulic brake device of a bicycle

(76) Inventor: Szu-fang Tsai, Changhua (TW)

Correspondence Address: SAM CHEN, 7F-1, 293, ROOSEVELT ROAD, SEC 3, TAIPEI, TW

(21) Appl. No.: 11/955,401

(22) Filed: Dec. 13, 2007

(51) Int. Cl. B60T 11/16

(52) U.S. Cl. 188/344

(57) ABSTRACT

An adjustable pumping device for a hydraulic brake device of a bicycle includes a body mounted to a handlebar of the bicycle and having a first tunnel defined therein for containing oil. A main cylinder is disposed in the body and pumps oil to the hydraulic brake device of the bicycle. A lever is pivotally mounted to the body and has an adjuster mounted in the lever for adjusting an ineffective stroke of the main cylinder.

### BACKGROUND OF THE INVENTION

1. Field of the Invention

The present invention relates to a pumping device, and more particularly to an adjustable pumping device for a hydraulic brake device of a bicycle.

2. Description of Related Art

A hydraulic brake system of a bicycle is divided into a brake device and a pumping device for providing pressed oil to the brake device. A conventional pumping device of a bicycle in accordance with the prior art comprises a hollow body divided into a containing portion for containing oil and a receiving portion for receiving pumping elements, such as a piston and a spring. A lever is pivotally mounted to the body for operating the piston to pump oil to the brake device via an oil pipe.

A conventional pumping device in accordance with the prior art has no adjustable elements and the adjustable function such that the conventional pumping device can not be adjusted for various purposes of different user. Consequently, the manufacturer needs to produce pumping devices with different types to satisfy the various purposes of different user. Imperceptibly, the manufacturing cost is raised.

The present invention has arisen to mitigate and/or obviate the disadvantages of the conventional pumping device for a brake device of a bicycle.

### SUMMARY OF THE INVENTION

The main objective of the present invention is to provide an improved pumping device for a hydraulic brake device of a bicycle, wherein the ineffective stroke of a piston of the pumping device is adjustable.

To achieve the objective, the pumping device in accordance with the present invention comprises a body mounted to a handlebar of the bicycle and having a first tunnel defined therein for containing oil. A main cylinder is disposed in the body and pumps oil to the hydraulic brake device of the bicycle. A lever is pivotally mounted to the body and has an adjuster mounted in the lever for adjusting an ineffective stroke of the main cylinder. Consequently, the brake force from the hydraulic brake device of the bicycle is adjusted when the position of the piston is adjusted such that the pumping device of the present invention is suitable to various bicycles, such as a mountain bicycle, a racing bicycle or an ordinary bicycle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pumping device for a hydraulic brake device of a bicycle in accordance with the present invention;

FIG. 2 is an exploded perspective view of the pumping device in FIG. 1;

FIG. 3 is a cross-sectional view of the pumping device in FIG. 1;

FIG. 3A is another cross-sectional view of the pumping device in FIG. 1;

FIG. 3B is an operational view of the pumping device of the present invention in cross-section;

FIG. 4 is a cross-sectional of the pumping device of the present invention for showing the ineffective stroke of the piston is maximum;

FIG. 5 is an operational view of the pumping device in FIG. 4;

FIG. 6 is a cross-sectional view of the pumping device of the present invention for showing the ineffective stroke of the piston is minimum;

FIG. 7 is an operational view of the pumping device in FIG. 6; and

FIG. 8 is a cross-sectional view of the pumping device of the present invention for showing the mechanical advantage of the present invention being adjusted.

### DETAILED DESCRIPTION OF THE INVENTION

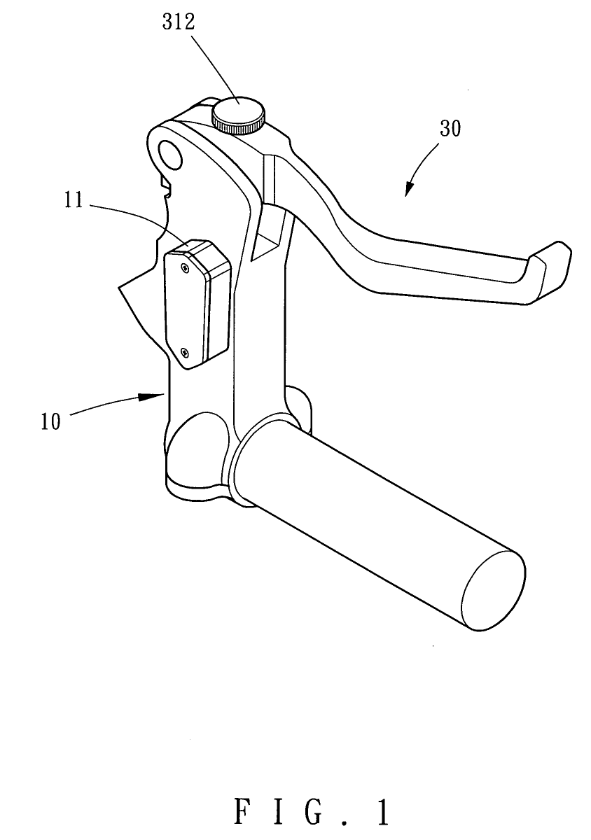

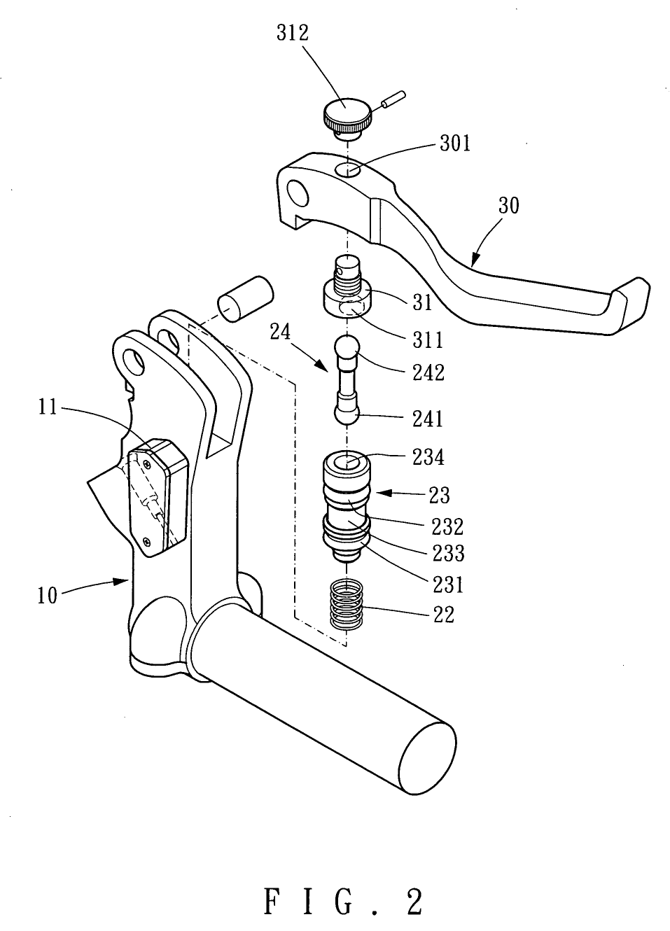

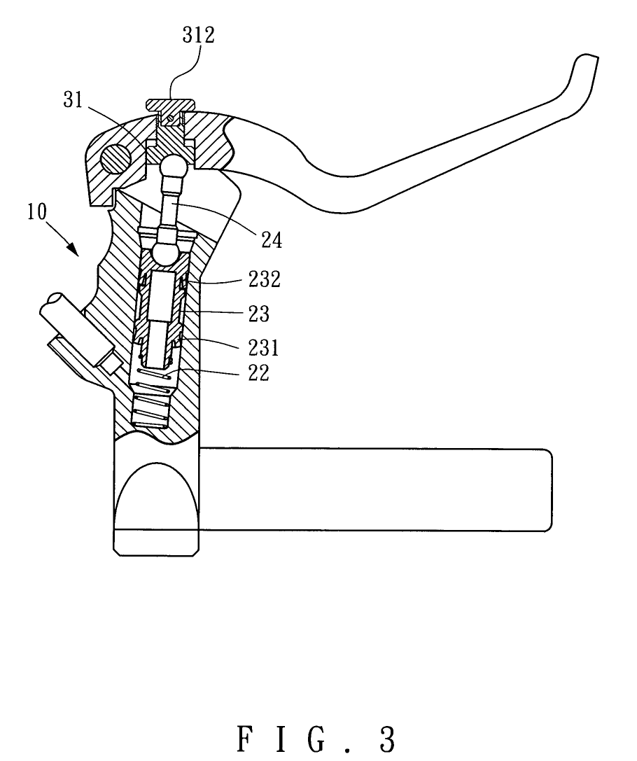

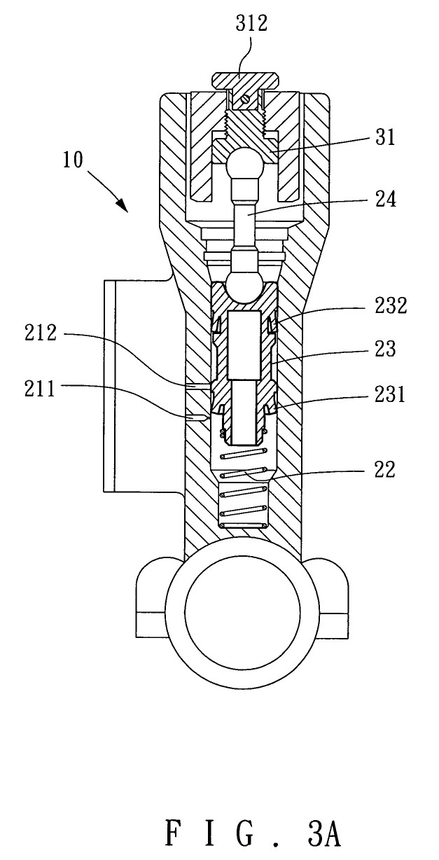

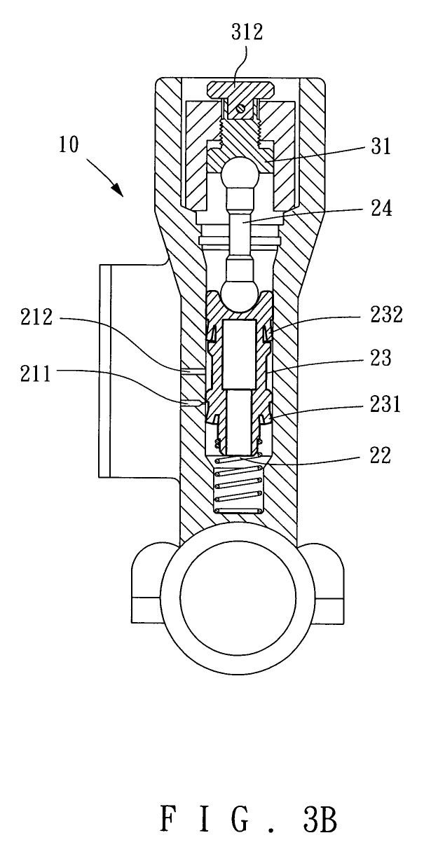

Referring to the drawings and initially to FIGS. 1-3B, a pumping device for a hydraulic brake device of a bicycle in accordance with the present invention comprises a body (10) adapted to be secured on a handlebar of the bicycle, a main cylinder (20) disposed in the body (10), a lever (30) pivotally mounted to the body (10) for operating the main cylinder (20). A first tunnel (11) is defined in the body (10) for containing oil and an oil pipe (40) is connected to the main cylinder (20) for transmitting the pumped oil to the hydraulic brake device of the bicycle for slowing down. An adjuster (31) is mounted to the lever (30) for adjusting an ineffective stroke of the main cylinder (20).

The main cylinder (20) has a second tunnel (21) defined in the body (10) and communicating with the first tunnel (1) via a first hole and a second hole (212) that are defined in the body (10), wherein the first hole (211) has a diameter smaller than that of the second hole (212) and the first hole (211) is located front of the second hole (212) relative to the main cylinder (20). The main cylinder (20) includes a spring (22), a piston (23), a linkage (24) and a stopper (25) sequentially and longitudinally mounted in the second tunnel (21). The stopper (25) is engaged to an inner periphery of the second tunnel (21) to prevent the spring (22), the piston (23) and the linkage (24) from detaching from the second tunnel (21) in the body (10). The spring (22) has two opposite ends respectively and longitudinally abutting against a bottom of the second tunnel (21) and the piston (23) to hold the piston (23) and the linkage (24) in place in the second tunnel (21).

The piston (23) has a first oil seal (231) and a second oil seal (232) respectively sleeved on two opposite ends of the piston (23). The first oil seal (231) and the second oil seal (232) respectively and airtightly abutting against the inner periphery of the second tunnel (21). The first oil seal (231) is located between the first hole (211) and the second hole (212) when the piston (23) is in a free condition, and the second oil seal (232) is never moved over the second hole (212). The piston (23) has an annular groove (233) defined between the first oil seal (231) and the second oil seal (232) and selectively communicating with the second hole (212). The annular groove (233) temporarily contains the oil from the first tunnel (11) when the piston (23) is moved within the ineffective stroke and the second oil seal (232) is provided to prevent the main cylinder (20) from a leakage. A first dimple (234) is defined in one end of the piston (23) opposite to the spring (22) for universally receiving one end of the linkage (24).

The linkage (24) extends through the stopper (25) and universally connected to the adjuster (13). The linkage (24) has a first ball (241) and a second ball (242) formed on two opposite ends of the linkage (24). The first ball (241) is partially universally received in the first dimple (234) in the piston (23) and the second ball (242) is universally connected to the adjuster (31).

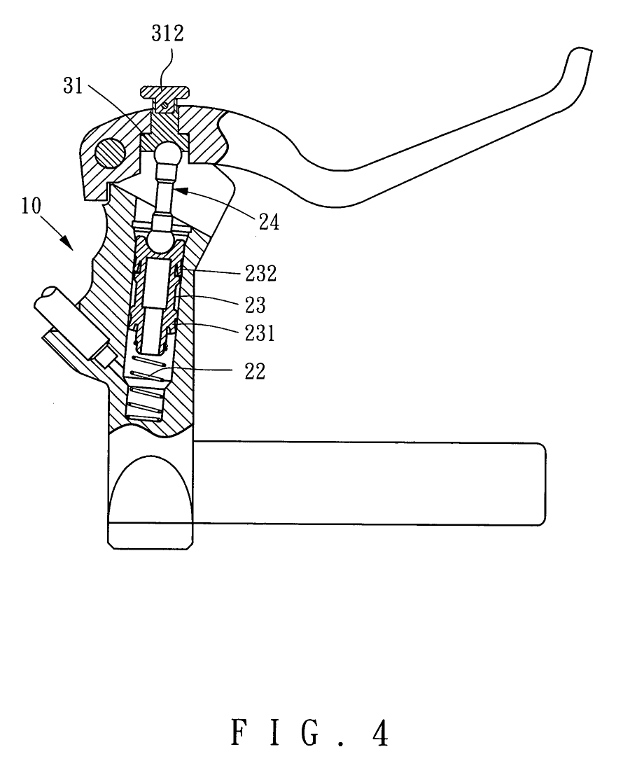

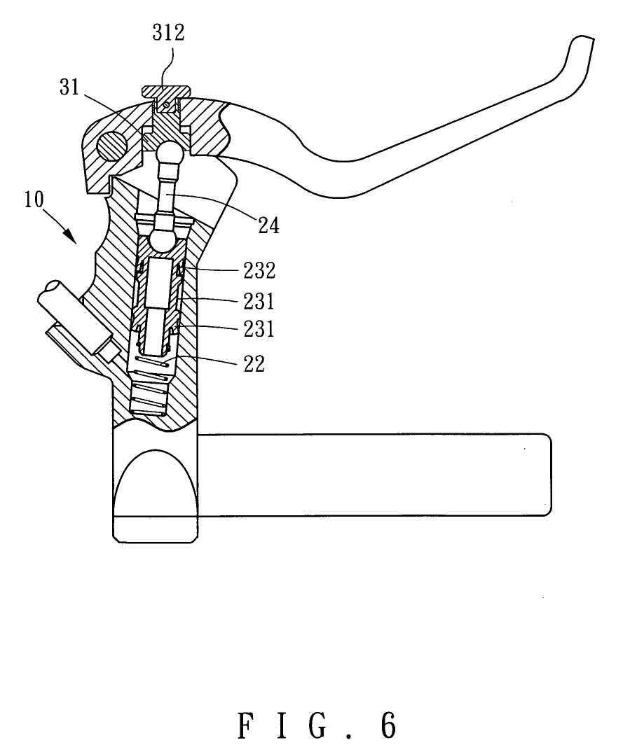

The lever (30) has a threaded hole (301) defined therein and extending therethrough and the adjuster (31) is rotatably mounted in the threaded hole (301) such that the adjuster (31) is linearly moved along an axis of the threaded hole (301) for adjusting a distance between the first oil seal (231) and the first hole (211), and the ineffective stroke of the piston (23), as shown in FIGS. 4 and 6, when the adjuster (31) is rotated relative to the lever (30). The axis of the threaded hole (301) directs to the second tunnel (21). The adjuster (31) has a second dimple (311) eccentrically defined therein for partially and universally receiving the second ball (242) of the linkage (24). A knob (312) extends into the threaded hole (301) and longitudinally connected to the adjuster (31) for user to easily rotate the adjuster (31).

The linkage (24) drives the piston (23) moved toward the bottom of the second tunnel (21) when the lever (30) is wrenched. The oil, in the main cylinder (20), flows into the annular groove (233) sequentially via the first hole (211), the first tunnel (11) and the second hole (212) when the first oil seal (231) is moved between the first hole (211) and the second hole (212). Now, the movement of the piston (23) is defined as an ineffective stroke. The oil, in the main cylinder (20), is compressed and pumped into the hydraulic brake device of the bicycle via the oil pipe (40) when the first oil seal (211) moved over the first hole (211). Now, the movement of the piston (23) is defined as an effective stroke. The first oil seal (231) is reciprocally moved relative to the first hole (211). The first hole (211) is defined to have a small gauge to prevent the opening of the first hole (211) from damaging the first oil seal (231). In the preferred embodiment of the present invention, the gauge of the first hole (211) is 0.5 mm.

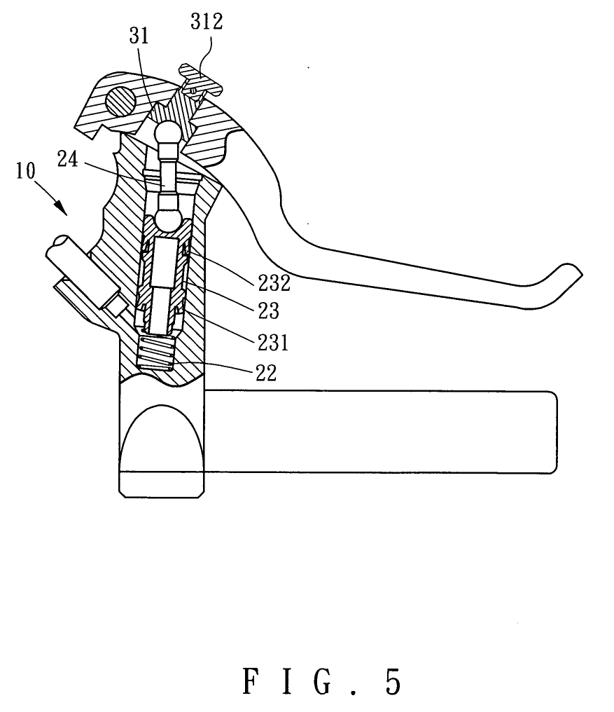

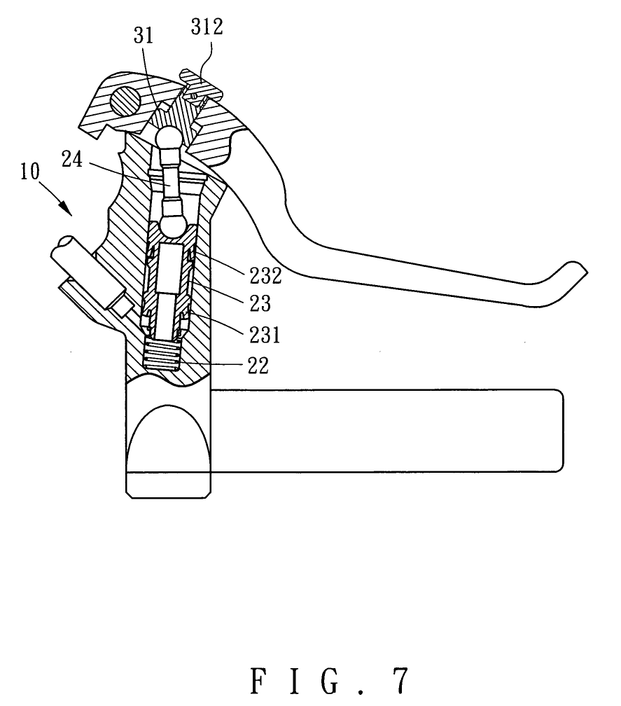

With reference to FIG. 4, the distance (ineffective stroke) between the first oil seal (221) and the first hole (211) is adjusted to a maximum. With reference to FIG. 6, the distance (ineffective stroke) between the first oil seal (221) and the first hole (211) is adjusted to a minimum. With reference to FIGS. 5 and 7, the total stroke (ineffective stroke and effective stroke) of the piston (23) of the main cylinder (20) is constant because the wrench range of the lever (30) is constant. The compressing efficacy of the piston (23) is minimum when the ineffective stroke of the piston (23) is adjusted to a maximum such that the reacting force from the hydraulic brake device of the bicycle is minimum and has a long time delay of the brake when wrenching the lever (30). On the contrary, the compressing efficacy of the piston (23) is maximum when the ineffective stroke of the piston (23) is adjusted to a minimum such that the reacting force from the hydraulic brake device of the bicycle is maximum and has a short time delay of the brake when wrenching the lever (30). Consequently, the rider can suitably use the adjuster (31) to adjust the distance between the piston (23) and the first hole (211) relative to the reality purpose thereof.

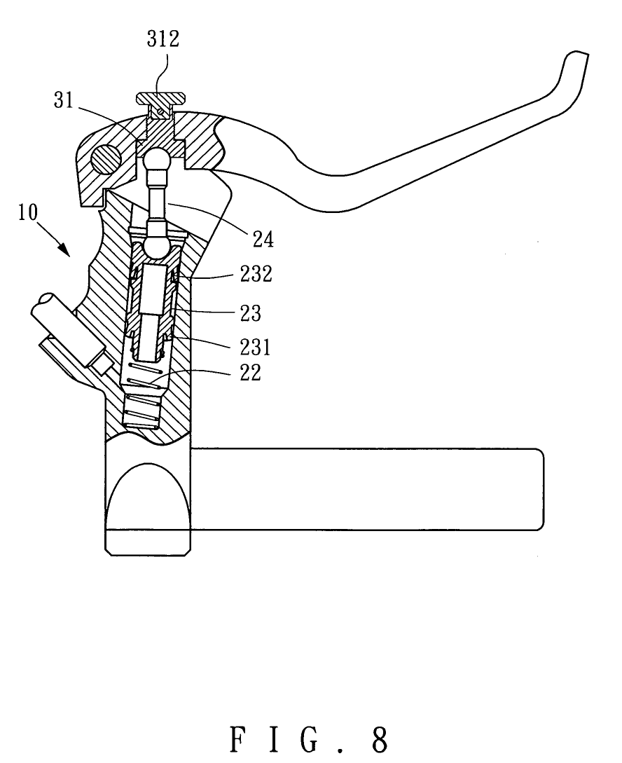

With reference to FIGS. 6 and 8, the pivot point between the lever (30) and the body (10) is defined as a fulcrum, the contact point between adjuster (31) and the linkage (24) is defined as a resisting point and the contact point between the lever (30) and user's palm is defined as a pressing point. As shown in FIG. 6, the distance between the resisting point and the fulcrum is maximum such that the mechanical advantage, in the condition, is minimum. The adjuster (31) drives the resisting point toward the fulcrum when the adjuster (31) is rotated due to the second dimple (311) that is eccentrically defined in the adjuster (31). The distance between the resisting point and the fulcrum is minimum when the adjuster (31) is rotated for 180 degrees, comparing FIG. 6 with FIG. 8. Consequently, the mechanical advantage, in the condition, is maximum.

As described above, the adjustable pumping device for a hydraulic brake device of a bicycle in accordance with the present invention has several advantages as follows.

1. The rider can suitably adjust the position of the piston (23) relative to the type of the bicycle and the riding conditions. The present invention not only provides an effective brake function, but also provides comfort during riding.

2. The mechanical advantage of the present invention can be adjusted to achieve the objective of labor-saving.

3. The brake force from the hydraulic brake device of the bicycle is adjusted when the position of the piston (23) is adjusted such that the pumping device of the present invention is suitable to various bicycles, such as a mountain bicycle, a racing bicycle or an ordinary bicycle.

Although the invention has been explained in relation to its preferred embodiment, it is to be understood that many other possible modifications and variations can be made without departing from the spirit and scope of the invention as hereinafter claimed.

What is claimed is:

1. An adjustable pumping device for a hydraulic brake device of a bicycle, comprising:
a body adapted to be mounted to a handlebar of the bicycle and having a first tunnel defined therein for containing oil;
a main cylinder disposed in the body and adapted to pump oil to the hydraulic brake device of the bicycle; and
a lever pivotally mounted to the body and having an adjuster mounted in the lever for adjusting an ineffective stroke of the main cylinder.

2. The pumping device as claimed in claim 1, wherein the main cylinder comprises a second tunnel defined in the body and communicating with the first tunnel via a first hole and a second hole that are defined in the body, the first hole having a diameter smaller than that of the second hole and the first hole located front of the second hole relative to the main cylinder, the main cylinder including a spring, a piston, a linkage and a stopper sequentially and longitudinally mounted in the second tunnel, wherein the stopper is engaged to an inner periphery of the second tunnel to prevent the spring, the piston and the linkage from detaching from the second tunnel in the body, the spring having two opposite ends respectively and longitudinally abutting against a bottom of the second tunnel and the piston to hold the piston and the linkage in place in the second tunnel.

3. The pumping device as claimed in claim 2, wherein the piston comprises a first oil seal and a second oil seal respectively sleeved on two opposite ends of the piston, the first oil seal and the second oil seal respectively and airtightly abutting against the inner periphery of the second tunnel, the first oil seal located between the first hole and the second hole when the piston is in a free condition, and the second oil seal never moved over the second hole, the piston having an annular groove defined between the first oil seal and the second oil seal and selectively communicating with the second hole, the annular groove temporarily containing the oil from the first tunnel when the piston is moved within the ineffective stroke and the second oil seal provided to prevent the main cylinder from a leakage, a first dimple defined in one end of the piston opposite to the spring for universally receiving one end of the linkage.

4. The pumping device as claimed in claim 3, wherein the lever has a threaded hole defined therein and extending therethrough and the adjuster is rotatably mounted in the threaded hole such that the adjuster is linearly moved along an axis of the threaded hole for adjusting a distance between the first oil seal and the first hole when the adjuster is rotated relative to the lever.

5. The pumping device as claimed in claim 3, wherein the linkage extends through the stopper and universally connected to the adjuster, the linkage having a first ball and a second ball formed on two opposite ends thereof, the first ball partially universally received in the first dimple in the piston and the second ball universally connected to the adjuster.

6. The pumping device as claimed in claim 5, wherein the adjuster has a second dimple eccentrically defined therein for partially and universally receiving the second ball of the linkage, a knob extending into the threaded hole and longitudinally connected to the adjuster for user to easily rotate the adjuster.
